(19) United States
(12) Patent Application Publication
(10) Pub. No.: US 2018/0330850 A1
(43) Pub. Date: Nov. 15, 2018

(54) WIRE HARNESS MANUFACTURING METHOD AND WIRE HARNESS

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Hideaki ITOU, Mie (JP); Shigeto KATO, Mie (JP)

(73) Assignees: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(21) Appl. No.: 15/774,170

(22) PCT Filed: Nov. 7, 2016
(86) PCT No.: PCT/JP2016/082908

§ 371 Date: May 7, 2018

(30) Foreign Application Priority Data
Nov. 18, 2015 (JP) 2015-225388

(51) Int. Cl. H01B 13/012; B60R 16/02

(52) U.S. Cl. CPC H01B 13/012; B60R 16/0207

(57) ABSTRACT

The present invention aims to provide technology for making it possible to manufacture a wire harness without using an assembly jig board, and to manufacture a wire harness with improved dimensional accuracy. The wire harness is manufactured in the following manner. First, an electrical wire group that extends from each connector is provisionally tied together by winding a piece of provisional binding tape around a portion of the electrical wire group at a binding position that is distant from the connector. Next, electrical wire groups that are each tied together at a binding position are ultimately tied together by winding a piece of ultimate binding tape around the pieces of provisional binding tape.

### TECHNICAL FIELD

The present invention relates to a method for manufacturing a wire harness.

### BACKGROUND ART

Some kinds of wire harnesses that are mounted on a vehicle are three-dimensionally disposed in a vehicle. Even when such a wire harness that is to be three-dimensionally disposed in a vehicle is to be assembled, the wire harness is usually two-dimensionally spread on an assembly jig board and is assembled so that high dimensional accuracy can be achieved. Such a method for assembling a wire harness is disclosed in Patent Document 1, for example.

However, methods for manufacturing a wire harness using an assembly jig board cannot be easily adapted to automation.

Hence, Patent Document 2 discloses a method for manufacturing a wire harness without using an assembly jig board.

The wire harness disclosed in Patent Document 2 is formed by ultimately tying together a plurality of provisionally-tied harnesses that have markings at branching positions.

### CITATION LIST

### Patent Documents

Patent Document 1: JP 2004-22188A

Patent Document 2: JP 2011-249038A

### SUMMARY OF INVENTION

### Technical Problem

However, in the wire harness disclosed in Patent Document 2, markings are made on each of the provisionally-tied harnesses. Therefore, it is necessary to perform work to ultimately tie together a plurality of electrical wires that extend from a connector, while holding the electrical wires at the marking positions. When performing this ultimate tying, there is the risk of the marking positions being displaced, for example, and thus it is difficult to realize high dimensional accuracy.

Therefore, the present invention aims to provide technology for making it possible to manufacture a wire harness without using an assembly jig board, and to manufacture a wire harness with improved dimensional accuracy.

### Solution to Problem

To solve the above-described problem, a wire harness manufacturing method according to a first aspect is a wire harness manufacturing method for manufacturing a wire harness in which a plurality of connectors are connected via a plurality of electrical wires, the wire harness manufacturing method including: (a) a step of provisionally tying together a first electrical wire group that extends from a first connector, by winding a first piece of tape around a portion of the first electrical wire group at a first binding position that is distant from the first connector; (b) a step of provisionally tying together a second electrical wire group that extends from a second connector, by winding a second piece of tape around a portion of the second electrical wire group at a second binding position that is distant from the second connector; and (c) a step of ultimately tying together the first electrical wire group tied together at the first binding position and the second electrical wire group tied together at the second binding position, by winding a piece of ultimate binding tape around the first piece of tape and the second piece of tape.

A wire harness manufacturing method according to a second aspect is the wire harness manufacturing method according to the first aspect. At least one of the step (a) and the step (b) includes: a step of fixing the connector; and a step of squeezing the electrical wire group from the connector side to the binding position with the connector being fixed.

A wire harness manufacturing method according to a fourth aspect is the wire harness manufacturing method according to the first or second aspect, further including: (d) a step of provisionally tying together a third electrical wire group that extends from a third connector or another ultimate binding position, by winding a third piece of tape around a portion of the third electrical wire group at a third binding position that is distant from the third connector or the other ultimate binding position; (e) a step of provisionally tying together portions of the first electrical wire group and the second electrical wire group that extend from portions around which the piece of ultimate binding tape is wound, by winding a fourth piece of tape around the portions of the first electrical wire group and the second electrical wire group at a fourth binding position that is distant from the piece of ultimate binding tape; and (f) a step of ultimately tying together the third electrical wire group tied together at the third binding position and the first electrical wire group and the second electrical wire group tied together at the fourth binding position, by winding a second piece of ultimate binding tape around the third piece of tape and the fourth piece of tape.

A wire harness according to a fourth aspect is a wire harness in which a plurality of connectors are connected via a plurality of electrical wires, the wire harness including: a first electrical wire group that extends from a first connector and is provisionally tied together by a first piece of tape wound around a portion of the first electrical wire group at a first binding position that is distant from the first connector; and a second electrical wire group that extends from a second connector and is provisionally tied together by a second piece of tape wound around a portion of the second electrical wire group at a second binding position that is distant from the second connector. The first electrical wire group and the second electrical wire group are ultimately tied together by a piece of ultimate binding tape wound around the first piece of tape and the second piece of tape.

### Advantageous Effects of Invention

According to the first to third aspects, it is possible to separately perform provisional binding on the first electrical group and the second electrical wire group, and gather the first electrical group and the second electrical wire group that have each been provisionally tied together, to perform ultimate binding. As a result, it is possible to manufacture a wire harness without using an assembly jig board. In this regard, the electrical wire groups that extend from the connectors are provisionally tied together, collectively for each connector. Therefore, it is possible to improve the dimensional accuracy regarding the provisional binding positions. Also, when ultimately tying together the first electrical wire group and the second electrical wire group all at once, it is only necessary to wind a piece of ultimate binding tape around the pieces of tape used for the provisional binding. Thus, it is possible to prevent the electrical wires from being displaced, for example. As a result, it is possible to prevent dimensional accuracy from degrading when performing ultimate binding. As described above, it is possible to manufacture a wire harness without using an assembly jig board, and manufacture a wire harness with improved dimensional accuracy. Also, even if the manufacturing of a wire harness is automated, it is possible to manufacture a wire harness with high dimensional accuracy.

In particular, according to the second aspect, even if intermediate portions of electrical wires at a position between a connector and a provisional binding position are warped due to the influence of deformation or the like of the electrical wires, it is possible to provisionally tie an electrical wire group together after straightening out the warp so as to be in a taut state by squeezing the electrical wire group. As a result, it is possible to improve the dimensional accuracy of each electrical wire at a provisional binding position.

Also, according to the third aspect, the method includes a step in which provisional binding at a branching point that is to be formed later is performed with reference to a branching point that has been previously formed. Therefore, it is possible to improve the dimensional accuracy regarding the secondary branching positions and provisional binding positions that are to be formed thereafter.

According to the fourth aspect, provisional binding is separately performed on the first electrical wire group and the second electrical wire group, and the electrical wire groups that each have been provisionally tied together are gathered and ultimately tied together. As a result, it is possible to manufacture a wire harness without using an assembly jig board. In this regard, the electrical wire groups that extend from the connectors are provisionally tied together, collectively for each connector. Therefore, it is possible to improve dimensional accuracy regarding the provisional binding positions. Also, when ultimately tying together the first electrical wire group and the second electrical wire group all at once, it is only necessary to wind a piece of ultimate binding tape around the pieces of tape used for the provisional binding. Thus, it is possible to prevent the electrical wires from being displaced, for example. As a result, it is possible to prevent dimensional accuracy from degrading when performing ultimate binding. As described above, it is possible to manufacture a wire harness without using an assembly jig board, and manufacture a wire harness with improved dimensional accuracy. Also, even if the manufacturing of a wire harness is automated, it is possible to manufacture a wire harness with high dimensional accuracy.

### BRIEF DESCRIPTION OF DRAWINGS

FIG. 1 is a diagram showing an example of a wire harness that is to be manufactured.

FIG. 2 is a diagram showing a step of a wire harness manufacturing method according to an embodiment.

FIG. 3 is a diagram illustrating how electrical wire groups that extend from connectors are provisionally tied together.

FIG. 4 is a diagram illustrating how the electrical wire groups that extend from the connectors are provisionally tied together.

FIG. 5 is a diagram illustrating how the electrical wire groups that extend from the connectors are provisionally tied together.

FIG. 6 is a diagram illustrating how the electrical wire groups provisionally tied together are ultimately tied together.

FIG. 7 is a diagram showing a step of the wire harness manufacturing method according to the embodiment.

FIG. 8 is a diagram illustrating how provisional binding at secondary branching positions is performed.

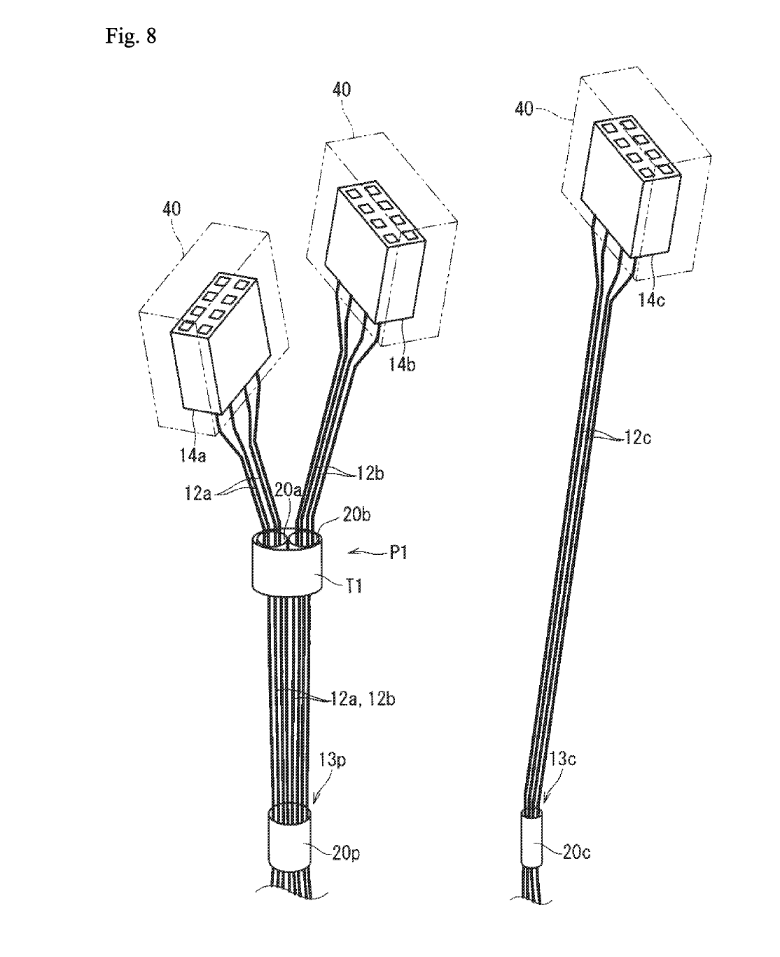

FIG. 9 is a diagram illustrating how ultimate tying at the secondary branching positions is performed.

FIG. 10 is a diagram showing a step of the wire harness manufacturing method according to the embodiment.

### DESCRIPTION OF EMBODIMENTS

### Embodiment

The following describes a wire harness manufacturing method according to an embodiment.

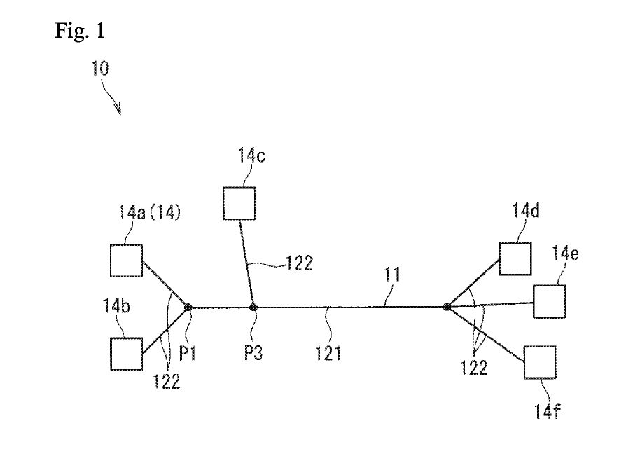

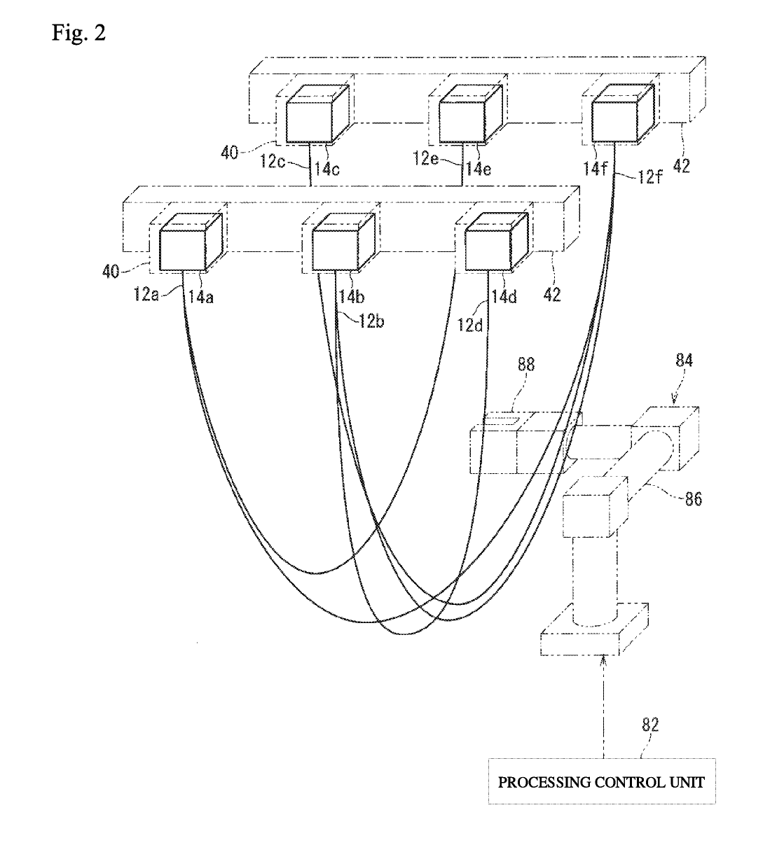

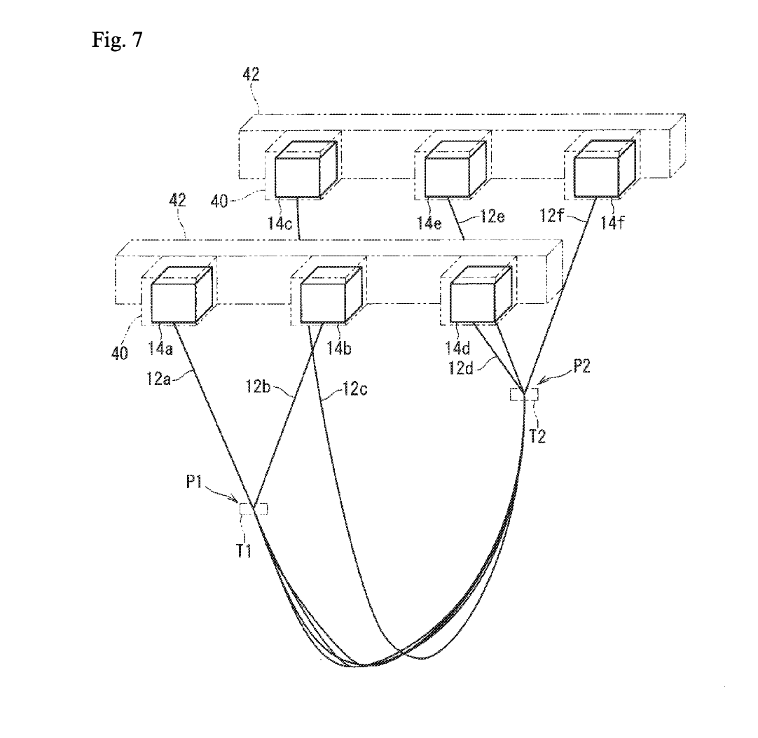

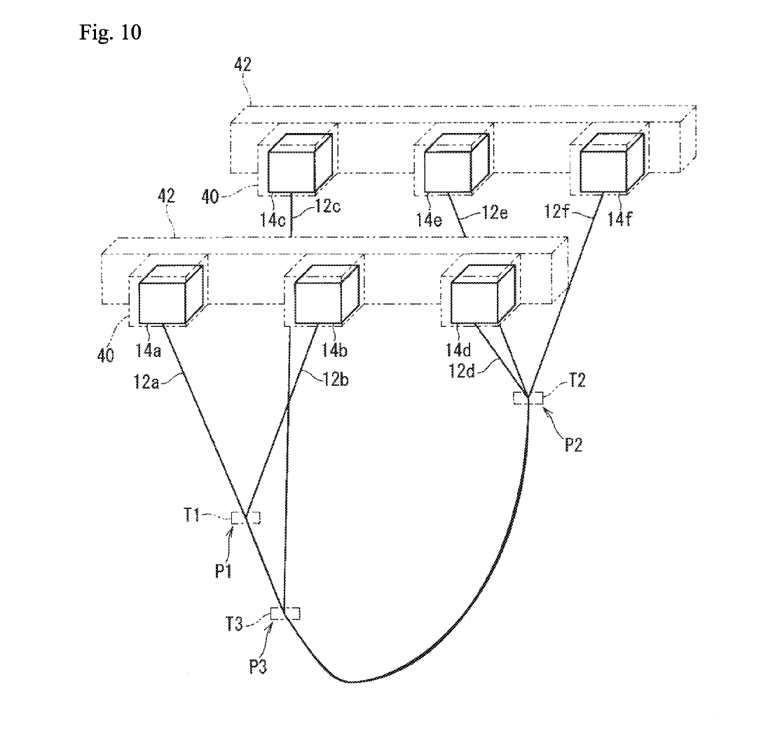

First, the following describes a wire harness 10 that is manufactured through the wire harness manufacturing method according to the embodiment, with reference to FIG. 1. FIG. 1 is a developed plan view of an example of the wire harness 10 that is manufactured through the wire harness manufacturing method according to the embodiment. In FIG. 1, note that electrical wires 11 that pass along the same path are depicted as a single line. Therefore, in FIG. 1, a single line may actually be a plurality of electrical wires 11 (the same applies to FIGS. 2, 7, and 10).

The wire harness 10 that is to be processed includes a plurality of connectors 14 that are connected via a plurality of electrical wires 11. More specifically, the wire harness 10 has a configuration in which the plurality of electrical wires 11 are divided into branches and tied together. From the branches of the wire harness 10, the electrical wires 11 are inserted into and connected to the connectors 14. This wire harness 10 is built into a vehicle, and the connectors 14 are connected to various kinds of electronic components that are mounted on the vehicle. Thus, the wire harness 10 serves to electrically connect various kinds of electronic components that are mounted on the vehicle. The electrical wires 11 included in the wire harness 10 are divided into branches and tied together according to installation routes in the vehicle.

Each electrical wire 11 includes a core, which is a wire rod that is mainly made of a metal such as copper or aluminum, and an insulative coating that envelops the core. The insulative coating is, for example, a member that is mainly made of a synthetic resin such as polyethylene, vinyl chloride, or polyamide nylon.

As described above, the connectors 14 are connected to end portions of the electrical wires 11. The electrical wires 11 are connected to the connectors 14 via, for example, terminals that are press-fitted or welded to, and thus connected to, the end portions of the electrical wires 11. Note that the terminals are, for example, metal members that are mainly made of a metal such as copper or tin.

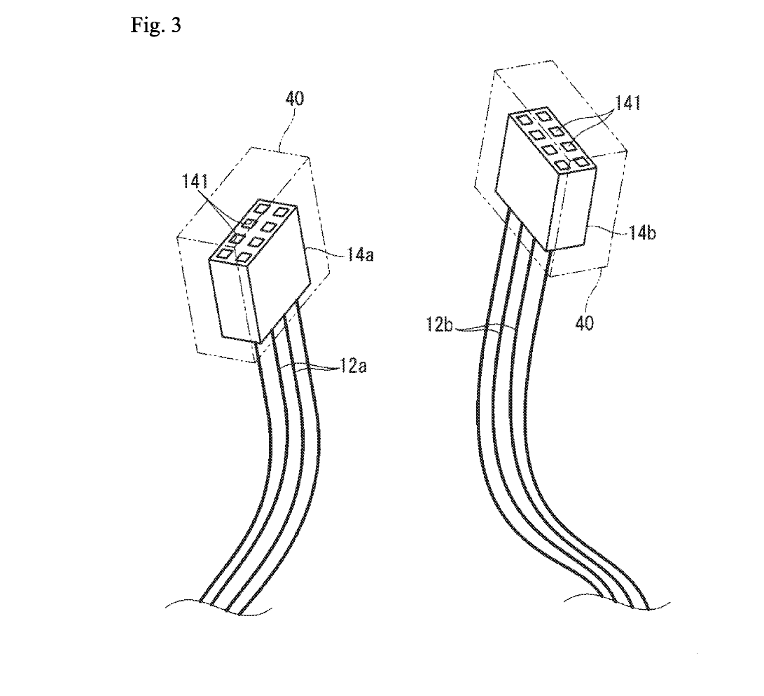

The body of each connector 14 is, for example, formed as an integrated piece using an insulative resin material such as a polybutylene terephthalate (PBT) or ABS resin. A plurality of cavities 141 are formed in the main surface, which is the surface to which electrical wires 11 are to be connected, of the body of each connector 14 (see FIG. 3).

The cavities 141 are open structures that house end portions (e.g. terminals) of electrical wires 11. Each cavity 141 has a certain depth in a direction that is, for example, substantially orthogonal to the main surface of the body of the connector 14. The electrical wires 11 housed in the cavities 141 are positioned and held at a predetermined depth in the cavities 141. Although the number of cavities 141 preferably corresponds to the number of electrical wires 11, the number is not particularly limited to such a number. In the present embodiment, a total number of eight cavities 141 are provided in rows and columns. However, it is only necessary that a plurality of cavities 141 are provided. In addition, it is not necessary that the cavities 141 have the same depth and the same width, and a cavity 141 that has a different depth and width may be included.

A connector 14 in which electrical wires 11 are held in the cavities 141 thereof is connected to a partner connector at a surface that is opposite the main surface thereof, for example.

In the following description, the case of manufacturing the wire harness 10 that branches off as shown in FIG. 1 will be described as an example. Of course, a wire harness 10 that has a different branch shape may be manufactured. In the wire harness 10, two branch lines 122 extend from an end portion of a trunk line 121 on one side, three branch lines 122 extend from an end portion of the trunk line 121 on the other side, and one branch line 122 extends from an intermediate portion of the trunk line 121. In this regard, connectors 14 are connected to end portions of the branch lines 122. In the following description, the connectors 14 are assigned identification signs and are referred to as a connector 14a and so on when they need to be specifically distinguished form each other. Also, as with the connector 14a and an electrical wire group 12a that extends therefrom, connectors 14 and an electrical wire group 12 that extends therefrom are referred to using the same identification sign assigned.

In some cases, branching points are referred to as a primary branching point or a secondary branching point, in order from the connector 14 side. That is, a primary branching point is a branching point that is formed by assembling portions of electrical wires 11 that extend from connectors 14, relative to which no branching points are formed on the connector 14 side. A secondary branching point is a branching point that is formed between primary branching points, and relative to which no branching points are formed on either primary branching point side.

Specifically, in the wire harness 10 shown in FIG. 1, the point where the branch lines 122 that extend from the trunk line 121 to connectors 14a and 14b branch off (a branching position P1) and the point where the branch lines 122 that extend from the trunk line 121 to the connectors 14d, 14e, and 14f branch off (a branching position P2) are primary branching points. Also, in the wire harness 10 shown in FIG. 1, the point where the branch line 122 that extends from the trunk line 121 to the connector 14c branches off (a branching position P3) is a secondary branching point. The configuration of each branching point will be described later in detail.

Note that there is the possibility of the wire harnesses 10 being only provided with primary branching points. There is also the possibility of three or more-ordinal branching points being provided.

### Manufacturing Method

The following describes the method for manufacturing the wire harness 10 according to the embodiment.

First, electrical wires 11 are inserted into each connector 14, and thus a wire harness in which wiring is complete and the electrical wires 11 have not been tied together is prepared. Next, each connector 14 into which electrical wires 11 are inserted is fixed. As shown in FIG. 2, the connectors 14 are respectively held by connector holders 40. Next, the connector holders 40 are fixed to frames 42 or the like. Thus, the connectors 14 are fixed. In this regard, in the example, the connectors 14 are fixed such that the openings of the cavities 141 face downward in the vertical direction. However, such a configuration is not essential.

After the connectors 14 are fixed, electrical wires 11 are tied together, one set after another. In the following description, it is assumed that a processing robot 84 is used to perform tying work. First, the processing robot 84 will be described.

The processing robot 84 is a typical industrial robot. FIG. 2 shows a typical vertically multi-jointed robot. The processing robot 84 includes a robot arm 86 and a processing operation unit 88 that is provided at a leading end portion of the robot arm 86. The robot arm 86 has a configuration in which a plurality of arm portions are coupled to each other with joint mechanisms therebetween so as to be rotatable about their respective shafts. The processing operation unit 88 is provided at a leading end portion of the robot arm 86. The processing robot 84 operates the robot arm 86 to move the processing operation unit 88 to any positions relative to the frames 42, in any orientation.

The processing operation unit 88 performs processing including processing for forming branches from the electrical wires 11. In this example, the processing operation unit 88 performs, as processing for forming branches, processing for collecting portions of electrical wires 11 at predetermined positions in the direction in which the electrical wires 11 extend, to a certain position (bundling up intermediate portions of a plurality of electrical wires 11 in the direction in which the electrical wires 11 extend), and processing for tying a plurality of electrical wires 11 together by winding a piece of adhesive tape therearound.

To perform the former process, various kinds of components, including a known robot hand that can grip and move an electrical wire 11 to a certain position, and that can grip and collect a plurality of electrical wires 11, can be used as the processing operation unit 88. To perform the latter process, various kinds of components, including a known automatic tape winder, can be used as the processing operation unit 88.

Also, in the following description, processing for squeezing electrical wires 11 is performed as processing for forming branches, in addition to the aforementioned processing. Processing for squeezing electrical wires 11 is, for example, processing that is performed by gripping electrical wires 11 with a gripping portion, and sliding the grip portion that is in such a state, along the electrical wires 11, in a direction in which the electrical wires 11 extend. By performing this processing, it is possible to correct deformation of the electrical wires 11, or bring the electrical wires 11 into a taut state. That is, by squeezing electrical wires 11 before tying the electrical wires 11 together, it is possible to prevent the electrical wires 11 from being tied together in a state where the electrical wires 11 are partially warped. Thus, it is possible to improve dimensional accuracy. To perform such processing, it is possible to employ various kinds of components as the processing operation unit 88, including a known robot hand that can grip electrical wires 11 with a force that allows the robot hand to slide along the electrical wires 11. Thus, it is envisioned that the robot arm 86 slides the robot hand along the electrical wires 11.

In order to perform a plurality of types of processing operations, a plurality of processing robots 84 may be provided. Alternatively, a plurality of processing operation units 88 may be provided at a leading end of the robot arm 86 so as to be movable relative to each other.

Note that the processing robot 84 may be a vertically multi-jointed robot, a rectangular coordinate type robot, or the like. The processing operation unit is changed as appropriate according to the operation that is to be performed on the electrical wire groups 12.

A processing control unit 82 is constituted by a typical computer that includes a CPU, a RAM, a ROM, an input circuit unit, and so on. The ROM is constituted by, for example, a rewritable non-volatile semiconductor memory such as a flash memory. The ROM stores, for example, programs that describe processing procedures and the details of the processes that are to be performed on the electrical wire groups 12. The CPU executes the programs that are stored in the ROM, thereby performing processes to provide the processing robot with various instructions.

Note that the processing robot 84 may perform various kinds of processing on the electrical wire groups 12 based on image data acquired by an image acquisition system that is separately provided. If this is the case, the ROM may store, for example, programs that describe procedures for determining the area to be processed and the position, orientation, and so on of the objects to be processed (electrical wire groups 12) based on the image data acquired by the image acquisition system or the like.

In the following description, it is assumed that a primary branching point is formed first. First, to form a primary branching point, the electrical wire group 12a and an electrical wire group 12b are each provisionally tied together.

Specifically, in a state where the connector 14a (14b) is fixed, the electrical wire group 12a (12b) extends downward in the vertical direction from the connector 14a (14b) as shown in FIG. 3. At this time, due to the influence of deformation or the like that occurred when the electrical wires 11 were manufactured, some portions of the electrical wires 11 may be bent at a position between the connector 14a (14b) and a binding position 13a (13b).

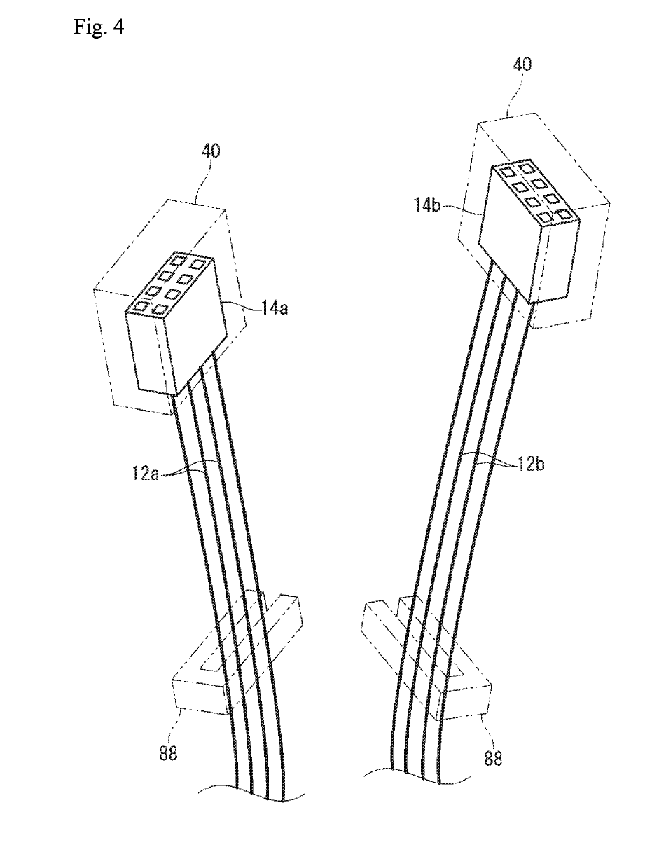

To straighten out such bent portions, here, as shown in FIG. 4, the electrical wire group 12a (12b) is squeezed from the connector 14a (14b) side to the binding position 13a (13b). Specifically, the robot arm 86 moves the processing operation unit 88 to the binding position 13a (13b) along the electrical wire group 12a (12b) with the processing operation unit 88 lightly gripping the electrical wire group 12a (12b). At this time, the processing operation unit 88 keeps gripping a position that is more distant from the connector 14a (14b) than the binding position 13a (13b) is. Also, it is preferable that the processing operation unit 88 performs squeezing while measuring the distance from the connector 14a (14b).

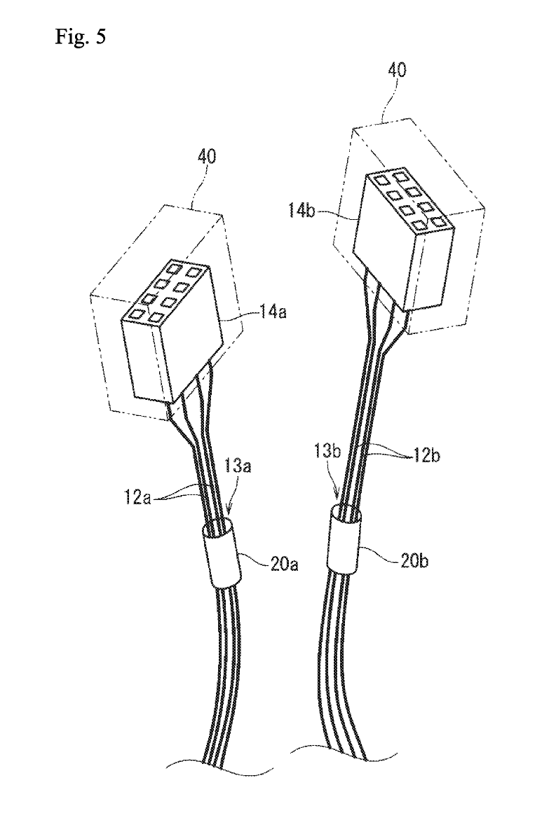

In this way, as a result of the processing operation unit 88 squeezing the electrical wire group 12a (12b) from the connector 14a (14b) side to the binding position 13a (13b) with the connector 14a (14b) being fixed, a portion of the electrical wire group 12a (12b) between the connector 14a (14b) and the binding position 13a (13b) is brought into a taut state. In this state, a piece of provisional binding tape 20a (20b) is wound around the electrical wire group 12a (12b) at the binding position 13a (13b). As a result, as shown in FIG. 5, the electrical wire group 12a (12b) is provisionally tied together at the binding position 13a (13b). At this time, the piece of provisional binding tape 20a (20b) may be wound a plurality of times at substantially the same position of the electrical wire group 12a (12b). Therefore, the piece of provisional binding tape 20a (20b) is wound around a portion of the electrical wire group 12a (12b) that is distant from the connector 14a (14b). In this regard, no piece of tape is wound around a portion of the electrical wire group 12a (12b) between the piece of provisional binding tape 20a (20b) and the connector 14a (14b).

After the electrical wire groups 12a and 12b are each provisionally tied together, the electrical wire groups 12a and 12b are each ultimately tied together. In this example, the electrical wire group 12a tied together at the binding position 13a and the electrical wire group 12b tied together at the binding position 13b are ultimately tied together by winding a piece of ultimate binding tape T1 around the pieces of provisional binding tape 20a and 20b.

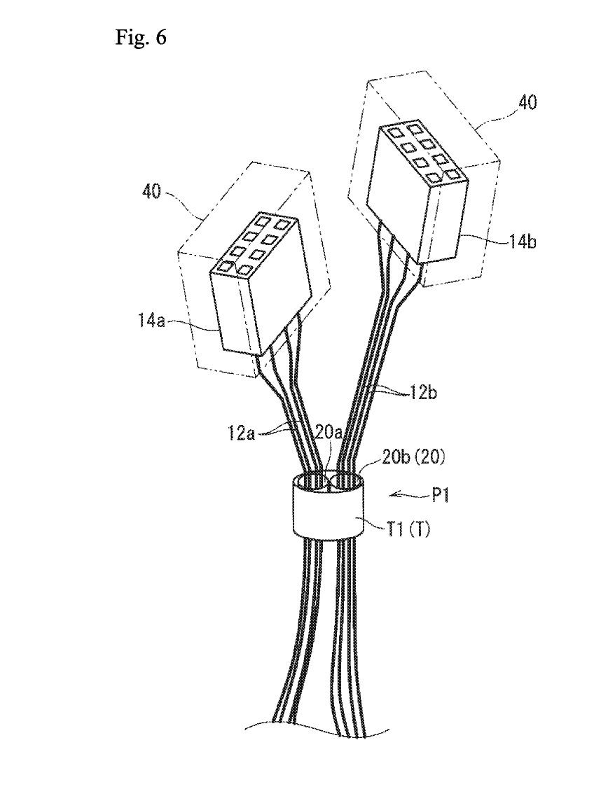

More specifically, after the electrical wire groups 12a and 12b are each provisionally tied together, the robot arm 86 moves the processing operation unit 88, with the processing operation unit 88 gripping a position in the vicinity of the pieces of provisional binding tape 20a and 20b. As a result, the electrical wire groups 12a and 12b are gathered together. At this time, the electrical wire groups 12a and 12b are gathered together such that the electrical wire groups 12a and 12b are substantially in the same orientation and the outer surfaces of the pieces of provisional binding tape 20a and 20b are in contact with each other. In this state, the piece of ultimate binding tape T1 is wound around the pieces of provisional binding tape 20a and 20b. As a result, as shown in FIG. 6, the electrical wire groups 12a and 12b are tied together at the branching position P1.

The electrical wire groups 12d, 12e, and 12f are also tied together in the same manner as with the electrical wire groups 12a and 12b. That is, in a state where the electrical wire groups 12d, 12e, and 12f have each been squeezed, pieces of provisional binding tape are wound around the binding positions so that each electrical wire group can be tied together. Next, portions of the electrical wire groups 12d, 12e, and 12f around which pieces of provisional binding tape are wound are gathered together, and a piece of ultimate binding tape T2 is wound around the pieces of provisional binding tape. As a result, the electrical wire groups 12d, 12e, and 12f are tied together at the branching position P2.

After the primary branching points are formed, a secondary branching point is formed next. The secondary branching point is also formed by performing provisional binding, and thereafter performing ultimate binding. In this regard, at least one instance of provisional binding is performed with reference to a primary branching point.

Specifically, first, the electrical wire group 12c and the electrical wire groups 12a and 12b are each provisionally tied together.

The provisional binding of the electrical wire group 12c is the same as the provisional binding of the electrical wire group 12a. That is, the electrical wire group 12c is squeezed from the connector 14c side to a binding position 13c. In this state, a piece of provisional binding tape 20c is wound around the binding position 13c so that the electrical wire group 12c can be tied together.

The electrical wire groups 12a and 12b are provisionally tied together at a binding position 13p that is more distant from the connectors 14a and 14b than the branching position P1 is. More specifically, first, the electrical wires 11 are squeezed from the branching position P1 (the piece of ultimate binding tape T1) to the binding position 13p in a direction away from the connectors 14a and 14b. Next, a piece of provisional binding tape 20p is wound around the binding position 13p, and thus the electrical wire groups 12a and 12b are provisionally tied together.

After the electrical wire group 12c and the electrical wire groups 12a and 12b are each provisionally tied together, the electrical wire groups 12a, 12b, and 12c are ultimately tied together. In this example, the electrical wire group 12c tied together at the binding position 13c and the electrical wire groups 12a and 12b tied together at the binding position 13p are ultimately tied together by winding a piece of ultimate binding tape T3 around the pieces of provisional binding tape 20c and 20p.

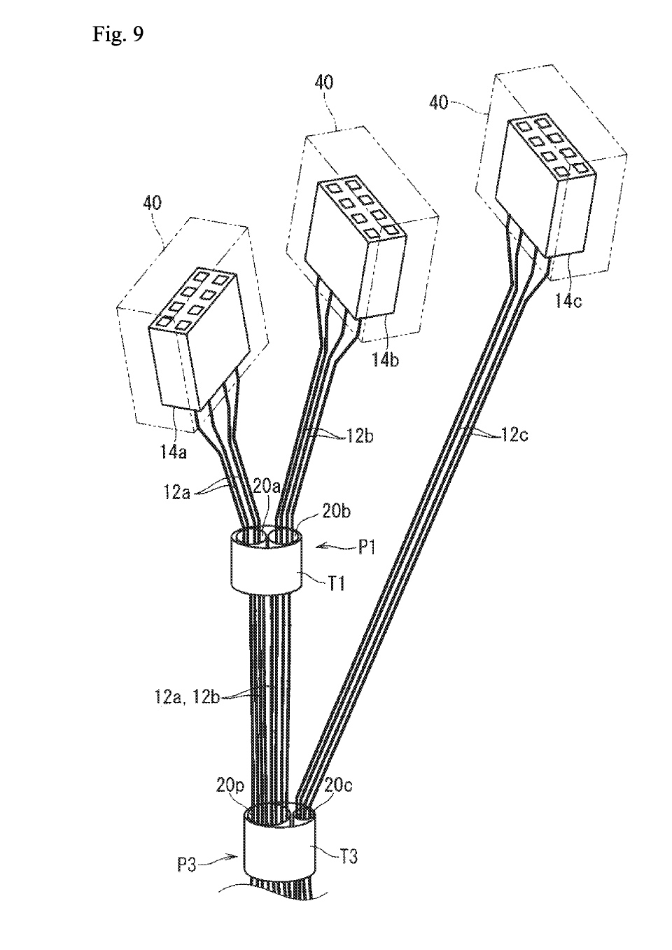

More specifically, after the electrical wire group 12c and the electrical wire groups 12a and 12b are each provisionally tied together, the processing operation unit 88 grips portions of the electrical wire group 12c and the electrical wire groups 12a and 12b in the vicinity of the pieces of provisional binding tape 20c and 20p, and moves the electrical wire groups 12a, 12b, and 12c. At this time, the electrical wire groups 12a, 12b, and 12c are gathered together such that portions of the electrical wire group 12c and the electrical wire groups 12a and 12b in the vicinity of the pieces of provisional binding tape 20c and 20p are substantially in the same orientation and the outer surfaces of the pieces of provisional binding tape 20c and 20p are in contact with each other. In this state, the piece of ultimate binding tape T3 is wound around the pieces of provisional binding tape 20c and 20p. As a result, as shown in FIG. 9, the electrical wire groups 12a, 12b, and 12c are tied together at the branching position P3.

Thus, the wire harness 10 in which the primary branching points and the secondary branching point are formed is manufactured. When a wire harness that has tertiary and higher-order branching points is to be manufactured, it is preferable that at least one instance of provisional binding of tertiary and higher-order branching point is performed with reference to a lower-order branching point in the same manner as with the secondary branching points.

Therefore, in this example, the branching points of the wire harness 10 are formed in the following manner. That is, the electrical wire groups 12 that respectively extend from the connectors 14 are each provisionally tied together with a piece of provisional binding tape 20 wound around a portion that corresponds to a branching position. Next, in a state where the electrical wire groups that each have been provisionally tied together are gathered together, a piece of ultimate binding tape T is wound around pieces of provisional binding tape 20 that have already been wound, and thus the electrical wire groups are ultimately tied together at the branching position.

More specifically, the wire harness 10 has the following configuration at the branching position P1, which is a primary branching point.

That is, the electrical wire group 12a that extends from the connector 14a and the electrical wire group 12b that extends from the connector 14b are provisionally tied together. The electrical wire group 12a is provisionally tied together at the binding position 13a that is distant from the connector 14a. The electrical wire group 12a is provisionally tied together by the piece of provisional binding tape 20a wound therearound. The electrical wire group 12b is provisionally tied together at the binding position 13b that is distant from the connector 14b. The electrical wire group 12b is provisionally tied together by the piece of provisional binding tape 20b wound therearound.

Next, the electrical wire groups 12a and 12b are ultimately tied together by the piece of ultimate binding tape T1 wound around the pieces of provisional binding tape 20a and 20b (see FIG. 6).

Similarly, at the other branching position P2, which is a primary branching point, the electrical wire group 12d that extends from the connector 14d, the electrical wire group 12e that extends from the connector 14e, and the electrical wire group 12f that extends from the connector 14f are each provisionally tied together by a piece of provisional binding tape. Next, the electrical wire groups 12d, 12e, and 12f are ultimately tied together by the piece of ultimate binding tape T2 wound around the pieces of provisional binding tape.

Also, in this example, the wire harness 10 has the following configuration at the branching position P3, which is a secondary branching point.

That is, the electrical wire group 12c that extends from the connector 14c is provisionally tied together. The electrical wire group 12c is provisionally tied together at the binding position 13c that is distant from the connector 14c. The electrical wire group 12c is provisionally tied together by the piece of provisional binding tape 20c wound therearound. The electrical wire groups 12a and 12b are provisionally tied together at the binding position 13p that is distant from the branching position P1. The electrical wire groups 12a and 12b are provisionally tied together by the piece of provisional binding tape 20p wound therearound.

Next, the electrical wire groups 12a, 12b, and 12c are ultimately tied together by the piece of ultimate binding tape T3 wound around the pieces of provisional binding tape 20c and 20p (see FIG. 9).

With such a wire harness 10 and the manufacturing method thereof, it is possible to separately perform provisional binding on each electrical wire group 12, thereafter gather together the electrical wire groups that each have been provisionally tied together, and perform ultimate binding. As a result, it is possible to manufacture the wire harness 10 without using an assembly jig board. In this regard, the electrical wire groups 12 that extend from the connectors 14 are provisionally tied together, collectively for each connector 14. Therefore, it is possible to improve dimensional accuracy regarding the provisional binding positions. In particular, it is possible to easily form branches from connectors that have different terminal lengths. Also, when ultimately tying together the electrical wire groups 12 all at once, it is only necessary to wind a piece of ultimate binding tape around the pieces of tape used for the provisional binding. Thus, it is possible to prevent the electrical wires 11 from being displaced, for example. As a result, it is possible to prevent dimensional accuracy from degrading when performing ultimate binding. As described above, it is possible to manufacture the wire harness 10 without using an assembly jig board, and manufacture the wire harness 10 with improved dimensional accuracy.

Also, the manufacturing method can be adapted to automation of the manufacturing of the wire harness 10. Even in this case, it is possible to manufacture the wire harness 10 with high dimensional accuracy.

Also, even if intermediate portions of electrical wires 11 at a position between a connector 14 and a provisional binding position are warped due to the influence of deformation or the like of the electrical wires 11, it is possible to provisionally tie together an electrical wire group 12 after straightening out the warp so as to be in a taut state by squeezing the electrical wire group 12. As a result, it is possible to improve the dimensional accuracy of each electrical wire 11 at a provisional binding position.

Also, the method includes a step in which provisional binding at a branching point that is to be formed later is performed with reference to a branching point that has been previously formed. Therefore, it is possible to improve dimensional accuracy regarding the secondary branching positions and provisional binding positions that are to be formed thereafter. In this regard, the electrical wire groups 12a and 12b are each collectively tied together. Therefore, it is possible to reduce the number of times the provisional binding is performed.

### Modifications

The embodiment describes the provisional binding of at least one secondary branching point being performed with reference to a primary branching point. However, this is not essential. The provisional binding of all of the secondary branching points may also be performed with reference to the connectors 14 in the same manner as with the primary branching points. More specifically, before the electrical wire groups 12a and 12b are ultimately tied together at the primary branching position P1, a piece of provisional binding tape is wound around a portion of the electrical wire group 12a corresponding to the branching position P3 so that the electrical wire group 12a is provisionally tied together, and a piece of provisional binding tape is wound around a portion of the electrical wire group 12b corresponding to the branching position P3 so that the electrical wire group 12b is provisionally tied together separately from the electrical wire group 12a. Next, the electrical wire group 12a, the electrical wire group 12b, and the electrical wire group 12c, which have each been provisionally tied together, may be gathered together, and a piece of ultimate binding tape may be wound around the pieces of provisional binding tape so that the electrical wire group 12a, the electrical wire group 12b, and the electrical wire group 12c are ultimately tied together. If this is the case, there are also cases in which primary branching points are formed after secondary branching points have been formed.

In addition, the embodiment describes branching points being formed using the processing robot 84. However, this is not essential. Branching points may be manually formed by an operator.

The configurations described in the embodiment and modifications above may be combined as appropriate as long as there are no inconsistencies with each other.

Although the present invention has been described above in detail, the descriptions above are illustrative in all respects, and the present invention is not limited to the descriptions. It should be understood that numerous modifications that are not illustrated can be conceived without departing from the scope of the present invention.

### LIST OF REFERENCE NUMERALS

10: Wire Harness
11: Electrical Wire
12: Electrical Wire Group
13a, 13b, 13c, 13p: Binding Position
14: Connector
20a, 20b, 20c, 20p: Piece of Provisional Binding Tape
40: Connector Holder
42: Frame
P1, P2, P3: Branching Position
T1, T2, T3: Piece of Ultimate Binding Tape

1. A wire harness manufacturing method for manufacturing a wire harness in which a plurality of connectors are connected via a plurality of electrical wires, the wire harness manufacturing method comprising:
(a) provisionally tying together a first electrical wire group that extends from a first connector, by winding a first piece of tape around a portion of the first electrical wire group at a first binding position that is distant from the first connector;
(b) provisionally tying together a second electrical wire group that extends from a second connector, by winding a second piece of tape around a portion of the second electrical wire group at a second binding position that is distant from the second connector; and
(c) ultimately tying together the first electrical wire group tied together at the first binding position and the second electrical wire group tied together at the second binding position, by winding a piece of ultimate binding tape around the first piece of tape and the second piece of tape.

2. The wire harness manufacturing method according to claim 1,
wherein at least one of the provisionally tying together of the first electrical wire group and the provisionally tying together of the second electrical wire group includes:
fixing the connector; and
squeezing the electrical wire group from the connector side to the binding position with the connector being fixed.

3. The wire harness manufacturing method according to claim 1, further comprising:
(d) provisionally tying together a third electrical wire group that extends from a third connector or another ultimate binding position, by winding a third piece of tape around a portion of the third electrical wire group at a third binding position that is distant from the third connector or the other ultimate binding position;
(e) provisionally tying together portions of the first electrical wire group and the second electrical wire group that extend from portions around which the piece of ultimate binding tape is wound, by winding a fourth piece of tape around the portions of the first electrical wire group and the second electrical wire group at a fourth binding position that is distant from the piece of ultimate binding tape; and
(f) ultimately tying together the third electrical wire group tied together at the third binding position and the first electrical wire group and the second electrical wire group tied together at the fourth binding position, by winding a second piece of ultimate binding tape around the third piece of tape and the fourth piece of tape.

4. A wire harness in which a plurality of connectors are connected via a plurality of electrical wires, the wire harness comprising:
a first electrical wire group that extends from a first connector and is provisionally tied together by a first piece of tape wound around a portion of the first electrical wire group at a first binding position that is distant from the first connector; and
a second electrical wire group that extends from a second connector and is provisionally tied together by a second piece of tape wound around a portion of the second electrical wire group at a second binding position that is distant from the second connector,
wherein the first electrical wire group and the second electrical wire group are ultimately tied together by a piece of ultimate binding tape wound around the first piece of tape and the second piece of tape.

5. The wire harness manufacturing method according to claim 2, further comprising:
(d) provisionally tying together a third electrical wire group that extends from a third connector or another ultimate binding position, by winding a third piece of tape around a portion of the third electrical wire group at a third binding position that is distant from the third connector or the other ultimate binding position;
(e) provisionally tying together portions of the first electrical wire group and the second electrical wire group that extend from portions around which the piece of ultimate binding tape is wound, by winding a fourth piece of tape around the portions of the first electrical wire group and the second electrical wire group at a fourth binding position that is distant from the piece of ultimate binding tape; and
(f) ultimately tying together the third electrical wire group tied together at the third binding position and the first electrical wire group and the second electrical wire group tied together at the fourth binding position, by winding a second piece of ultimate binding tape around the third piece of tape and the fourth piece of tape.
